(19) United States
(12) Patent Application Publication
(10) Pub. No.: US 2012/0144981 A1
(43) Pub. Date: Jun. 14, 2012

(54) FOOT CONTROLLER

(76) Inventor: Massimiliano Ciccone, London (GB)

(21) Appl. No.: 13/390,772

(22) PCT Filed: Aug. 19, 2010
(86) PCT No.: PCT/EP2010/062073

§ 371 Date: Feb. 16, 2012

(30) Foreign Application Priority Data
Aug. 20, 2009 (EP) 09168343.3

(51) Int. Cl. G10H 1/32

(52) U.S. Cl. 84/746

(57) ABSTRACT

A foot controller for electrically controlling a device by a user may include at least one sensor pad module having a first plate of dielectric material. The first plate of dielectric material may support at least two electrodes forming a planar capacitor. The controller may further include a second plate of dielectric material separated from the first plate by a layer of compressible dielectric material. The first plate is adapted to be displaced with respect to the second plate, so as to vary the geometry of an equivalent capacitor which includes the at least two electrodes, the compressible dielectric material and the second plate of dielectric material, thereby varying the value of the capacitance of the equivalent capacitor. The foot controller may further include a control module adapted to generate an electrical control signal which depends on the value of the capacitance.

### FIELD OF THE INVENTION

The invention relates to a foot controller for generating control signals and to a method for generating control signals from a foot controller

The invention may, in particular, be targeted to musicians needing to control musical instruments or sound processing devices, e.g. sound processors, amplifiers, sound effects, etc, while playing their instruments.

### BACKGROUND OF THE INVENTION

Conventional foot controllers for use with devices such as sound processors, amplifiers, and other similar electronic devices feature a number of foot-operable switches—for instance of the push-button type (e.g. momentary or latching push-button switches)—through which a musician can switch on or off a certain feature of the sound processor being controlled, or increment or decrement by a fixed, non-adjustable quantity, a counter (controlling, for instance, a program or preset change). The fact that such switches are to be operated by foot is at the root of some of the well-known problems that users experience when operating a conventional foot controller. In order to ensure a sturdy construction and to prevent involuntary operation, these foot-operable switches tend to be rather bulky and require a significant amount of physical effort by the user to operate them. This leads to relatively large, non ergonomically-optimal design of said foot controllers, which, in turn, force the musician to perform ample movements with his/her leg and foot when operating the controller.

Additionally, a musician may be required to operate these switches a considerable number of times during the course of a musical performance, since it is common to switch sound presets many times during the one song, which may lead to fatigue problems for the performer, due to the physical effort involved. Furthermore, these foot-operable push-button-type switches have a limited lifespan, due to the presence of moving mechanical parts, and to the fact that they are often operated in a harsh manner: due to the mechanical resistance encountered when switching, the user may tend to impart much more force than necessary to obtain the switching action, so as to ensure that the switching action is successful. This manner of operating the switches clearly contributes to the limiting of their useful lifespan.

A further important problem inherent in foot controllers featuring foot-operable switches is the audible mechanical noise that the switches produce during the switching action. This noise is easily picked up by neighbouring microphones (e.g. for voice recording) and negatively affects the quality of the recording.

In addition, the use of (foot-operable) push-button switches limits the number and variety of controls that can be imparted using a foot controller of this type. These switches are capable, by design, of sending only one impulse (open/close, on/off, +1/−1) every time they are operated, that is, each time their electrical circuit condition is changed from the open status to the closed status, or vice versa. It is therefore immediately clear that in order to expand the number of controlling actions one can perform with this type of controller, only two possibilities exist: the number of switches in the foot controller must increase, leading to an even larger and more difficult to operate controller (pressing the wrong switch during a live performance could have disruptive consequences for the continuity of the live musical act); or the user must repeatedly press the same switch to obtain the desired effect (for instance, he must press 10 times the same switch to increase the number of selected sound processing programmes by 10 units). Both options are less than desirable and their drawbacks are readily appreciated.

It would therefore be advantageous to have a foot controller that is more ergonomically optimised, requires less force and physical strength to operate, emanates less audible mechanical noise, and is more compact, while remaining cheap to build and sturdy. It would also be advantageous to have a foot controller that allows the user to impart a larger number of different controlling actions, without requiring an increase in its physical size or in the effort required by the musician to operate it.

To partially solve some of these problems, U.S. Pat. No. 3,225,274, introduces the concept of a capacitance-based foot controller. The device in U.S. Pat. No. 3,225,274 features two laterally-spaced coplanar plates, acting as capacitor's plates, and resilient dielectric material overlaying the plates. One of the plates is connected to an amplifier sending an electrical signal to the capacitance-based sensor, while the other plate is connected to ground. By shifting his weight over either one of the two plates, the operator increases the relative capacitance coupling between his foot and either one of the two plates, thereby increasing or decreasing the signal input to the amplifier and, therefore, the motor speed control signal. Although U.S. Pat. No. 3,225,274 sought to tackle some of the problems mentioned above, the solution proposed is not suitable for the foot controller, which is the object of the present application.

The problem with the device in U.S. Pat. No. 3,225,274 is that it uses the operator's foot as dielectric between the two capacitor plates, thus making the whole controller's electrical response sensitive to the characteristic of the shoe and/or foot of the operator. Although suitable for the stated purpose of U.S. Pat. No. 3,225,274 (controlling a motor for sewing machines), it is essential in the field of controllers for musical sound processor that controllers perform in an even, repeatable and uniform way. This is necessary in order to ensure that a performing musician, seeking to, for example, switch to a different effect during the execution of a song, can be certain that the controlling command will always be correctly interpreted by the controller without the need for repeated actions, and independently of the shoes s/he is wearing.

It would therefore be highly desirable for musician to have access to a foot controller—for the purpose of controlling, for example, a sound effect processor—that is ergonomically optimised for intensive use during live and/or studio performance but that does not degrade the quality of the delicate sound signal created by their instruments and/or the sound processing equipment in use.

The present invention overcomes all the problems described with reference to the prior art and provides a number of other advantageous features to musicians.

### SUMMARY OF THE INVENTION

An aspect of the present invention includes a foot controller for electrically controlling a device by a user. The foot controller may comprise at least one sensor pad module, which may be operated by foot, having a first plate of dielectric material. The first plate of dielectric material may support at least two electrodes forming a planar capacitor. The foot controller may further include a second plate of dielectric material which is separated from the first plate by a layer of compressible dielectric material, wherein the dielectric material forming said second plate has a dielectric constant ∈₁ (also known as relative static permittivity or relative dielectric constant) and the compressible dielectric material has a dielectric constant C₂ with ∈₁#∈₂, and wherein the first plate is adapted to be displaced with respect to the second plate, along the distance between said plates, by a force applied by an external object, so as to vary the geometry of the sensor pad module's equivalent capacitor, which includes said at least two electrodes, said compressible dielectric material and said second plate of dielectric material, thereby varying the value of the capacitance of said equivalent capacitor. The foot controller may further include a control module adapted to generate an electrical control signal which depends on the value of the capacitance.

In a further embodiment, the first dielectric plate of the foot controller may advantageously be constituted by a printed circuit board, wherein said printed circuit board may further comprise a first metallic layer on which said two electrodes are etched. The external force applied to the sensor pad module may induce an elastic (i.e. reversible) deformation on the flexible circuit board, thereby modifying the geometry of the variable equivalent capacitor. In certain embodiments of the present invention, this construction may enable the realisation of a sensor pad module in which there are no hinged or rotatable moving parts and only the elastic deformation is responsible for the change in geometry of the variable capacitance. The foot controller thus obtained is characterised by an elevated degree of robustness and reliability. The mechanical simplicity of its construction makes it also particularly cheap to produce.

Further, the circuit board may comprise a second metallic layer connected to ground potential. The presence of this layer will prevent radiations from the capacitor on the sensor pad, since this is part of an oscillator circuit. This is advantageous when the foot controller is to be used in applications that are sensitive to electromagnetic (EM) disturbances, such as musical performances or in a medical environment.

Said first metallic layer and said second metallic layer are preferably on the opposite outer surfaces of said printed circuit board. Also preferably, said first metallic layer faces said layer of compressible dielectric material and said second metallic layer connected to the ground potential faces the user.

In another embodiment of the present invention, the sensor pad module of the foot controller is preferably at least partly enclosed in a fixed housing. The sensor pad module is advantageously solidly connected to the housing along the edges of the area occupied by the electrodes of the planar capacitor in such a way that the force applied to the pad by said external object only displaces the centre of the pad, with said displacement increasing progressively towards the centre of the pad.

In one embodiment of the present invention, the first plate of dielectric material is separated from said second plate of dielectric material by separation means, disposed along at least some of the edges of the area occupied by the electrodes of the planar capacitor. In one embodiment of the present invention, said separation means is a U-shaped element, which may be made of metal or plastic. In an alternative embodiment, said separation means include at least one compression spring or one coil spring.

In one embodiment of the present invention, the control module comprises an oscillator circuit which includes said second capacitor. The oscillator circuit may be adapted to produce a periodic waveform, whose period is proportional to the value of the capacitance of said second capacitor.

In one embodiment of the present invention, the control module may further include computational means adapted to extract the period of said waveform and to compare it with one or more predefined thresholds, and to perform a predetermined instruction according to the result of said comparison. In some embodiments of the present invention, said at least one or more threshold are settable by the user.

In a further embodiment of the present invention the housing at least partially enclosing the sensor pad module is made of metal and incorporates a third metallic layer connected to ground potential. By virtue of this metallic layer connected to ground, the equivalent capacitor is constituted of the series of the planar capacitor and of the parallel combination of capacitors having as electrodes one of the electrodes of the planar capacitor and said third metallic layer connected to ground.

These and other aspects, features and advantages of the invention will become apparent and more readily appreciated from the following detailed description of exemplary embodiments and from the accompanying drawings.

It is to be understood that both the foregoing general description and the following detailed description and drawings are exemplary and explanatory only and are not restrictive of the invention as claimed.

### BRIEF DESCRIPTION OF THE DRAWINGS

FIG. 1 shows a foot controller according to an embodiment of the present invention;

FIG. 2a illustrates in detail a sensor pad module included in the foot controller of the present invention, in its rest position;

FIG. 2b and FIG. 2c show the pad of FIG. 2a under the effect of externally-applied force;

FIG. 2d shows a schematic representation of the elements forming the equivalent capacitor of the sensor pad module;

FIG. 3a illustrates a possible topology of the planar capacitor included in the sensor pad module according to a preferred embodiment of the present invention;

FIG. 3b shows an exploded view of some of the elements included in the sensor pad module according to an embodiment of the present invention;

FIG. 4 shows a schematic of a square wave oscillator circuit, according to an embodiment the present invention;

FIG. 5 illustrates the sensing and control circuit of a foot controller according to an embodiment of the present invention;

FIG. 6 shows examples of the periodic square wave signals produced by the oscillator circuit;

FIG. 7 shows the electrical signals on some of the lines of a sensing and control circuit, according to a mode of operation of the present invention;

FIG. 8 illustrates the sensing and control circuit of a foot controller according to another embodiment of the present invention;

FIG. 9 illustrates a flowchart diagram of a method for generating control signals from a foot controller, in accordance with an embodiment of the present invention.

### DETAILED DESCRIPTION OF THE INVENTION

The foot controller and the method for generating control signals from the foot controller will be now described in detail with reference to the accompanying drawings. Wherever possible, the same reference numbers will be used throughout the drawings to refer to same or like parts, elements or operating steps.

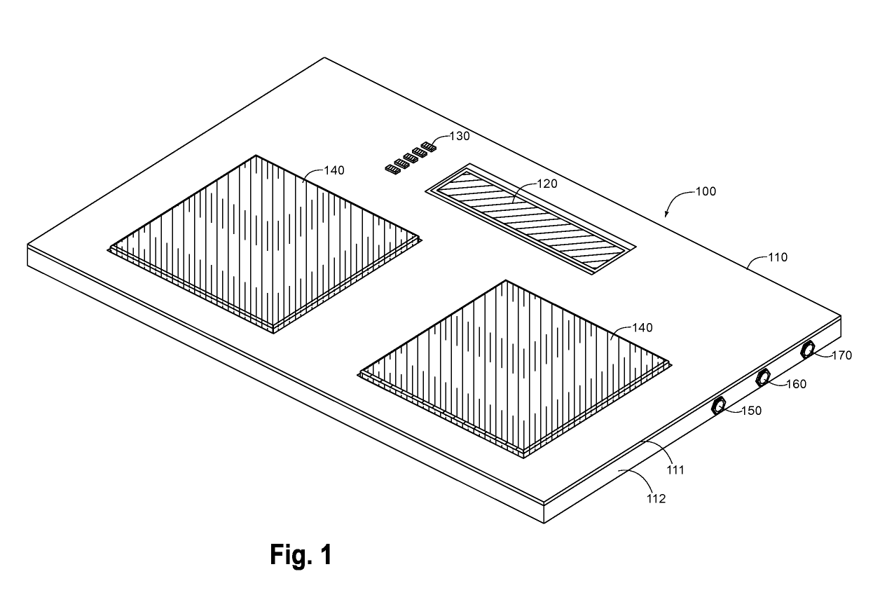

FIG. 1 shows a foot controller 100 according to an exemplary embodiment of the present invention. The controller may comprise a fixed housing 110. Housing 110 may comprise one or more elements, such as a top part 111 and a bottom part 112 connected to each other by means of screws or any other equivalent means, and may be constructed out of metallic, plastic or other materials. In an exemplary embodiment of the present invention the housing is made of steel. The skilled person will not have any difficulties in building the housing out of other materials such as aluminium, plastic, etc. The exemplary foot controller 100 may feature a number of connectors 150 to 170, which enable the foot controller to be connected to, e.g., a source of AC or DC power, one or more expression pedal(s) or similar variable-resistance control devices, a sound processor, a MIDI (Musical Instrument Digital Interface) device, an amplifier or a musical instrument capable of detecting and decoding the control signals sent by the foot controller 100. The foot controller 100 may further comprise display means 120 for displaying information sent to and received from the electronic devices connected thereto by means of connectors 150 to 170. Display means 120 may, for instance, take the form of a LCD display or of other similar display means known in the art, and provides the user with an immediate feedback of, for instance, the status and settings of the foot controller 100, the operation being performed by the controller, relevant information about the device(s) connected to the foot controller 100, calibration data, and other parameters, which are relevant to the user. Foot controller 100 may further comprise user feedback means 130, which may be used to provide the user with immediate visual feedback information about the operation being performed by the controller as a result of an action carried out by the user. User feedback means 130 may also be used to inform the user about which one(s) of the controller's selectable feature(s) is(are) enabled. User feedback means 130 may, for instance, be in the form of light emitting diodes (LEDs) devices. Other luminous or acoustic devices may replace or integrate LEDs as user feedback means 130 without departing from the scope of the present invention. Finally, foot controller 100 may comprise one or more pads 140. Pads 140 may be solidly or elastically connected to one or more of the sensor pad modules included in the foot controller and described later herein. Such sensor pad module(s) may be enclosed within housing 110 so as to lie directly under pads 140. Pads 140 may be made of rubber, plastic or other materials that are able to withstand the force applied by the user using his/her foot on pad 140 and to transmit the force to the pad sensor module underneath. The one or more pads 140 may be directly connected to the sensor pad modules (e.g. by means of glue, screws or other arrangements) or they may be connected by means of springs, levers, gears and similar mechanical arrangements adapted to transmit all or part of the force applied onto the pads 140 to the underlying sensor pad modules. It must be understood that the one or more pads 140 mainly serve the purpose of protecting the sensor pad modules underneath from the potential wearing action caused by the foot of the user while in operation but they do not contribute to, nor are they necessary for, the correct electrical or mechanical functioning of the present invention.

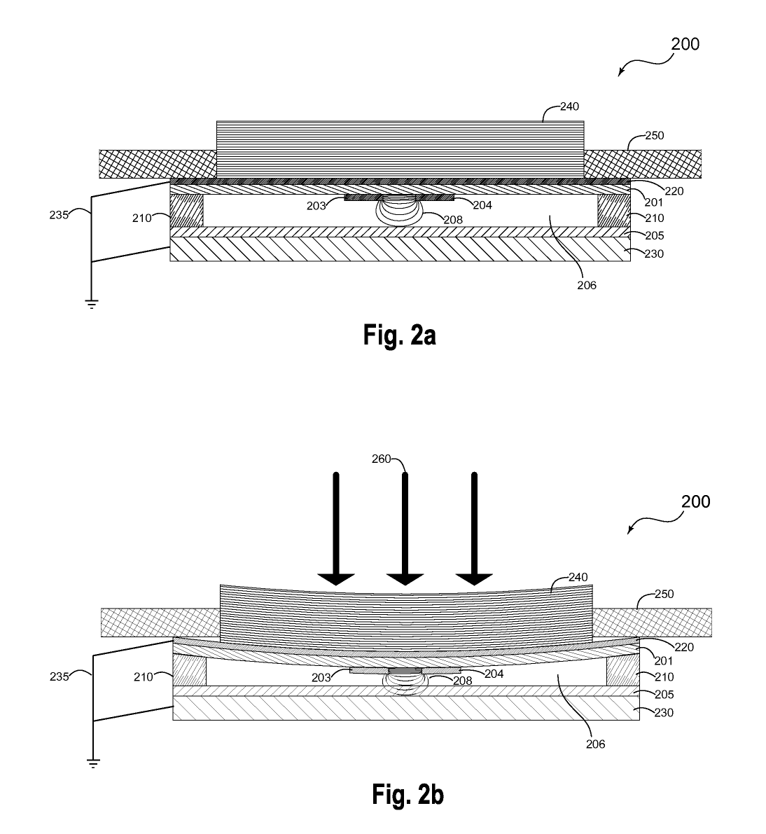

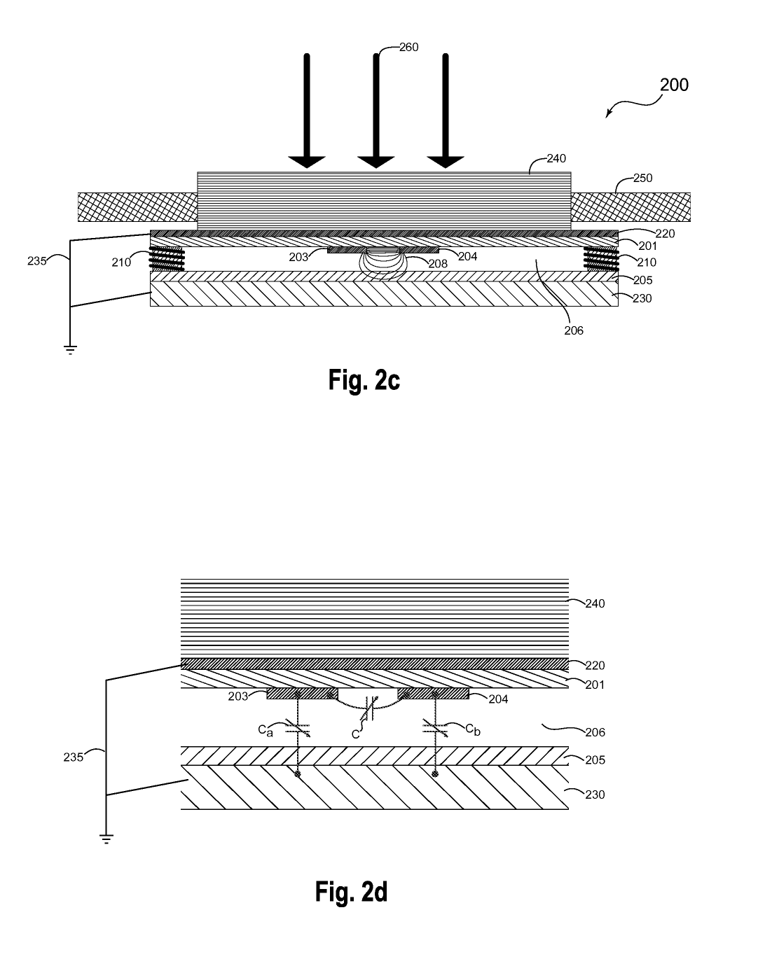

FIG. 2a shows a cross section of sensor pad module 200 according to a preferred embodiment of the present invention. The core of the sensor pad module 200 comprises a first plate 201 made of dielectric material. In one embodiment of the present invention, plate 201 may be made of a material adapted to be used as substrate for printed circuit boards (PCBs), such as the well-known FR-4 or other similar materials. Plate 201 further comprises at least two electrodes 203 and 204, jointly defining a planar capacitor C. Electrodes 203 and 204 may assume a variety of geometrical configurations and shapes, some of which will be described later herein by way of example, without departing from the scope of the present invention. The lines 208 connecting electrodes 203 and 204 in FIG. 2a to FIG. 2c, offer a simplified representation of the lines of the electric field, which exists between electrodes 203 and 204, when an electrical current is injected into the planar capacitor. For simplicity's sake and to enable a better understanding of the gist of the invention, in the schematic representation of the electric field 208, only a few lines are depicted, which are those more susceptible to be influenced by the changes in the geometry of the sensor pad module

The sensor pad module 200 further comprises a second plate 205 made of dielectric material, which is separated from plate 201 by a layer of compressible dielectric material 206. In an exemplary embodiment of the present invention, plate 205 may be made of a material adapted to be used as substrate for PCBs, such as the well-known FR-4 or other similar material. In a preferred embodiment of the present invention, plate 205 is constituted of a layer of paint (e.g. synthetic paint) applied to metallic layer 230, which will be described below. In an exemplary embodiment of the present invention, the layer of compressible dielectric material 206 may be constituted of air. Other compressible materials with dielectric properties may be used to replace air without departing from the scope of the present invention. Examples of such materials are various types of rubber, which may be used when the electric field 208 generated by the planar capacitor C between electrodes 203 and 204 is of sufficient strength. By replacing air with other dielectric materials in layer 206, the sensor pad module 200 may be made, for instance, more robust and able to withstand higher loads during its standard operating mode, which will be explained later herein. The dielectric material forming plate 205 may have a dielectric constant ∈₁, whereas said compressible dielectric material 206 may have a dielectric constant ∈₂. Choosing Å₁#∈₂ ensures the correct functioning of the foot controller according to the present invention, as it will be explained later in detail.

In case air is used as compressible dielectric layer 206, in order to ensure the separation between plates 201 and 205, one or more separation elements 210 may be used. In one embodiment of the present invention, separation elements 210 may be made of metal, rubber or plastic material. As it will be described in more detail later herein with reference to FIG. 2b, in one embodiment of the present invention, separation elements 210 may advantageously be rigid enough as to ensure that a force substantially perpendicular to the sensor pad module 200 and applied on the sensor pad module will cause plate 201 to deform and displace progressively more around the centre of the plate, while the parts of plate 201 resting on separation elements 210 will substantially remain at the same distance from plate 205. In this embodiment, plate 201 may advantageously be a printed circuit board, hereinafter ‘PCB’, on which electrodes 203 and 204 are etched—in the form of electrically conductive tracks made of, e.g., copper—according to well known PCB manufacturing processes. Also in this embodiment, plate 201 may be a PCB fabricated using a substrate with elastic properties, which will advantageously ensure that plate 201 returns to its original non-deformed state depicted in FIG. 2a, once the vertical force ceases to be applied on sensor pad module 200.

As it will be described in more detail with reference to FIG. 2c, in another embodiment, separation elements 210 may be constituted of one or more mechanical springs, e.g., compression springs, coil springs or cantilever springs, with a direction of compression along the distance between plates 201 and 205. In this embodiment, the vertical force applied downwardly on the sensor pad module 200 will cause plate 201 to rigidly displace towards plate 205, substantially without deformation. The one or more springs constituting separation elements 210 will in turn advantageously ensure that plate 201 returns to the rest position depicted in FIG. 2a, once the vertical force ceases to be applied on sensor pad module 200.

Sensor pad module 200 may further include a first metallic layer 220 and a second metallic layer 230. In one embodiment of the present invention, first metallic layer 220 may advantageously be etched on the surface of the PCB opposite to that where the planar capacitor formed by electrodes 203 and 204 is etched. Also advantageously, in one embodiment of the present invention, the second metallic layer 230 may be the bottom part of the housing enclosing the sensor pad module 200 (see element 112 of FIG. 1). Alternatively, the first metallic layer 220 may be the top part of said housing (element 111 of FIG. 1). First metallic layer 220 and second metallic layer 230 may extend at least over the whole surface occupied by the planar capacitor C formed by electrodes 203 and 204. First metallic layer 220 and second metallic layer 230 are connected to ground potential, as shown by connection 235. This has the effect of shielding the environment around sensor pad module 200 from the electric field 208 created by the capacitor formed by elements 203, 204, and 206 during the operation of the foot controller. In the case of the foot controller described in U.S. Pat. No. 3,225,274, it is essential for the correct functioning of the controller that the capacitor's plates are not electrically shielded from the environment. Only in this way, can they interact with the operator foot in the way described in the document. If they were shielded, the electromagnetic field between the plates would not be coupled to varying degrees with the foot and shoe of the operator. In order to sense the variation in capacitance, an alternated electrical signal is fed to the capacitor in U.S. Pat. No. 3,225,274. This alternated signal creates an electromagnetic field that radiates from the capacitor plates. In a musician's studio or in a live music performance set-up, such an electromagnetic field may be picked up by the other electronic devices present (e.g., amplifiers, sound effects, electric guitar's pickups, etc) and the electrical noise thus generated in said electronic devices may have highly detrimental effects for the sound quality. In an embodiment of the present invention, connecting metallic layers 220 and 230 connected to ground potential has the advantageous effect of confining electromagnetic radiations (such as electric field 208) within the sensor pad module. This makes it possible to use a foot controller including the sensor pad module 200 in situations where an electric field 208 radiating from the foot controller would be detrimental. This may be the case, for instance, when the foot controller is operated in the presence of other sensitive electronic devices, such as sound processors, stringed electrical music instruments and the likes, and sensitive medical instrumentation (for instance in hospitals or operating theatres).

Optionally, sensor pad module 200 may be provided with pad 240, depicted in FIG. 2a, which is substantially equivalent to pad 140 of FIG. 1. Pad 240 may be used to enable or facilitate the application of force onto sensor pad module 200 by the user, as it will be shown with reference to FIGS. 2b and 2c. Pad 240 may be made of rubber, plastic or other materials that are able to withstand the force applied by the user using, e.g., his/her foot on pad 240 and to transmit the force to plate 201 of pad sensor module 200 underneath. Pad 240 may be mechanically directly connected to the sensor pad modules (e.g. by means of glue, screws or other arrangements) or it may be connected by means of springs, levers, gears and similar mechanical arrangements adapted to transmit all or part of the force applied onto pad 240 to the sensor pad module underneath.

Finally, FIG. 2a shows element 250 which may be part of the housing enclosing the sensor pad module 200. In an exemplary embodiment, element 250 may, for instance, represent the top part element of the housing, such as element 111 of FIG. 1. Element 250 may be made of metal, plastic or other materials, and may advantageously cooperate in some embodiments of the invention with separation elements 210 in defining the rest position for plate 201 and assuring that plate 201 returns to its rest position once the force ceases to be applied on sensor pad module 200.

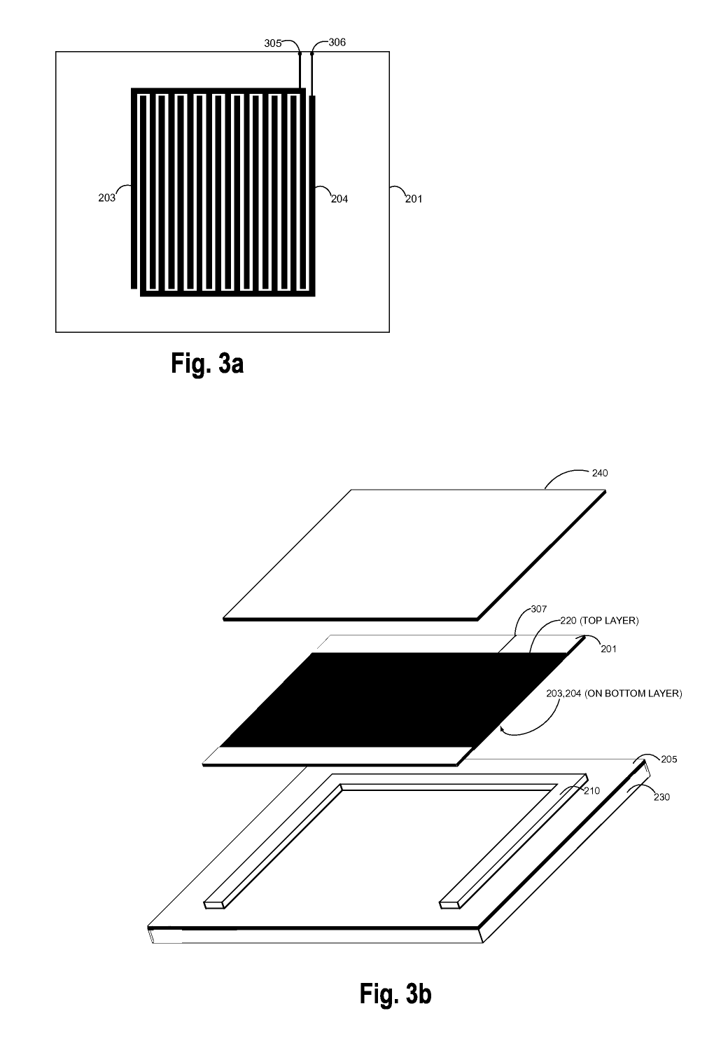

FIG. 2d shows the principal contributions to the total equivalent capacitor C_{eq} of the sensor pad module 200 of FIG. 2a (hereinafter referred to as equivalent capacitor). This is the total capacitor seen for instance between points 305 and 306 of FIG. 3a. As described above, electrodes 203 and 204 form a variable planar capacitor C. Furthermore, in case layer 230 is connected to ground potential, as exemplary shown in FIG. 2a, a variable parasitic capacitor Cₐ is formed between electrode 203 and layer 230, and a second variable parasitic capacitor C_{b} is formed between electrode 204 and layer 230. The values of the capacitance of capacitors C, Cₐ, and C_{b}, vary in a way that will be described shortly herein. During the functioning of the foot controller the total equivalent variable capacitor C_{eq} of the sensor pad module is given by:

$${C}_{eq} = C + \frac{{C}_{a} \cdot {C}_{b}}{{C}_{a} + {C}_{b}} . \qquad ( Eq . 1 )$$

It is clear from Eq. 1 that if layer 230 is not included in the construction of the sensor pad module C_{eq}=C. Throughout the rest of this description, the symbols C_{eq}, C, Cₐ and C_{b} will be used to indicate either the capacitors or their capacitance values, as appropriate.

FIG. 2b illustrates the principle behind the variation of capacitance in the sensor pad module under the effect of an externally-applied force. The force applied onto sensor pad module 200 is represented in FIG. 2b by lines 260. In a standard operating scenario, the user may apply substantially-perpendicular force onto pad 240 using his or her foot (not shown in the figure). It is, however, clear that applying force along lines 260 using the hand or another object is readily contemplated within the teaching of the present invention. In this embodiment, owing to the elastic properties of the dielectric material constituting plate 201, and to the higher rigidity of separation elements 210, the force applied onto sensor pad module 200 (via pad 240 in the embodiment depicted) results in plate 201 deforming progressively more towards the centre of the plate. Owing to the changed geometry of the equivalent capacitor C_{eq}, that is, of its constituting elements C, Cₐ, and C_{b} described above, it has been found by the inventor that the electric field generated by the current flowing into electrodes 203 and 204 is forced to readjust its spatial distribution, in order to take into account the variation in geometry of C_{eq} and the different spatial distribution of materials with different dielectric constants inside C_{eq}, thereby varying the value of the capacitance C_{eq}. The value of the capacitance C_{eq} therefore varies when force is applied on sensor cap module 200, which cause plate 201 to deform as exemplarily shown in FIG. 2b. The more force is applied, the greater the resulting deformation of plate 201, and the greater the variation of the value of capacitance C_{eq}. In particular, for ∈₁>∈₂, the value of capacitance C_{eq} will increase as a result of there being proportionately more dielectric material with higher dielectric constant inside capacitor C_{eq}. Equivalent capacitor C_{eq} behaves therefore as a variable capacitor.

By choosing a material with a suitable Young modulus (or modulus of elasticity) for plate 201, the construction of sensor pad module 200, according to some embodiments of the present invention, ensures that the sensor pad module works under elastic regime and withstands the force applied with the foot by the user under normal operating conditions (for instance in the range 500-1000 N). This ensures that when force 260 is released, plate 201 returns to its rest condition depicted in FIG. 2a and that capacitance C_{eq} also returns to the initial value corresponding to the rest condition of plate 201. Materials such as the well-known PCB substrate material FR-4 present a Young modulus high enough for the purpose and, due to its wide availability and low price, constitute a very cost-effective choice for the realisation of plate 201. It is also to be noted that if the circuit (described later herein) used to detect and measure the variation of capacitance C_{eq} is sensitive enough, only small deformation of plate 201 are needed in order to sweep through a range of capacitance values wide enough to enable the foot controller to produce all the control signals required. The small geometrical solicitations and reduced mechanical stress of plate 201 mean, in turn, that the foot controller will be compact, robust, reliable, and easily repeatable and it will have a longer lifespan. These are all desirable characteristics that are not generally achievable with prior art foot controllers employing foot-operable push-button switches.

In the alternative embodiment of FIG. 2c, in which separation elements 210 may be constituted by compression or coil springs (optionally including a supporting core inside the spring, as shown in FIG. 2c), the spring constant of the springs may be such that applied force 260 causes the springs to compress and to absorb all the force applied by the user. In this configuration, plate 201, which may be made of the same material adapted to be used as substrate for PCBs, such as the well-known FR-4, will remain substantially flat even when force 260 is applied by the user. When plate 201 has assumed the position shown in FIG. 2c, under the effect of force 260 applied by the user, the geometry of capacitor C_{eq} has changed. Owing to the changed geometry of the equivalent capacitor C_{eqi}, that is, of its constituting elements C, Cₐ, and C_{b} described above, it has been found by the inventor that the electric field generated by the current flowing into electrodes 203 and 204 is forced to readjust its spatial distribution, in order to take into account the variation in geometry of C_{eq} and the different spatial distribution of materials with different dielectric constants inside C_{eq}, thereby varying the value of the capacitance C_{eq}. The value of the capacitance C_{eq} therefore varies when force is applied on sensor cap module 200, which cause plate 201 to be displaced towards plate 205, as shown in FIG. 2c. The more force is applied, the greater the resulting displacement of plate 201, and the greater the variation of the value of capacitance C_{eq}. In particular, for ∈ᵢ>∈₂, the value of capacitance C_{eq} will increase as a result of there being proportionately more dielectric material with higher dielectric constant inside capacitor C_{eq}. The capacitor C_{eq} behaves therefore as a variable capacitor. When force 260 ceases to be applied, the springs included in separation elements 210 will ensure that plate 210 return to its rest position, shown in FIG. 2a.

FIG. 3a shows a plan view of the electrode configuration of sensor pad module 200 according to a preferred embodiment of the invention. Electrodes 203 and 204 are arranged on one side of plate 201 as interdigitated comb-like electrodes in order to maximise the capacitance between electrodes. Advantageously, the electrodes 203 and 204 may cover an area approximately equivalent to that covered by pad 140 in FIG. 1, underneath which the electrodes may be lying (as shown in FIGS. 2a to 2c). Other configurations of interdigitated electrodes 203 and 204, such as spiral or serpentine shapes may be used instead of the configuration shown in FIG. 3a, without departing from the scope of this invention. Electrodes 203 and 204 are connected to an oscillator circuit via connection points 305 and 306. Connection points 305 and 306 are only shown by way of example as means to connect capacitor C to the oscillator circuit and do not necessarily represent physical connection points or connectors.

FIG. 3b shows an exploded view of some of the elements of a sensor pad module of the type depicted in FIG. 2a. Visible in FIG. 3b are metallic layer 230 (which may be the bottom part of the housing enclosing sensor pad module 200, as discussed earlier) and second dielectric plate 205, resting directly above metallic layer 230 (plate 205 and layer 230 may or may not be solidly connected). Separation element 210 is shown in FIG. 3b featuring an exemplary squared U-shaped design, the advantageous nature of which will be explained shortly. Separation element 210 rests directly on top of dielectric layer 205 and it is preferably solidly connected to metallic layer 230, using fixation means well known in the art (screws, studs, rivets, soldering, and so on). Dielectric plate 201 is shown here at a distance from separation element 210 for the purpose of making the drawing more clear, but it is to be understood that, as depicted in FIG. 2a to FIG. 2c, plate 201 rests directly above element 210 and in direct contact with it. Visible on the upper surface of plate 201 is first metallic layer 220 (ground plane) connected to ground potential, as explained above, via connection point 307. On the bottom surface of plate 201, although not visible in FIG. 3b, are electrodes 203 and 204, facing dielectric layer 205 and forming the variable capacitor. Again, in the case of pad 240, the distance between pad 240 and plate 201 in FIG. 3b only serves the purpose of clarifying the structure of the module. Finally, FIG. 3b shows pad 240, which is depicted here for clarity at a certain distance from plate 201. As seen in FIG. 2a to FIG. 2c, pad 240 may rest directly on top of plate 201, so that any force applied by the user onto pad 240 is transmitted directly to plate 201 causing one of the geometrical deformations of the sensor pad module depicted in FIG. 2b or FIG. 2c. Thanks to the design of the separation element 210 in the example shown in FIG. 3b, if the open side of the U-shaped separation element faces the user, it has been found that it is possible to realise a particularly ergonomic foot controller, in which the user may permanently rest his/her foot (not shown in FIG. 3b) on pad 240 without causing deformations to plate 201, due to the support provided thereto by the three other sides of element 210. When the user desires to impart a control signal, on the other hand, a small amount of force applied on pad 240 is enough, due to the open side of separation element 210, to deform plate 201 and change the value of the capacitance C_{eq}, as described with reference to FIG. 2b. A foot controller including the sensor pad module depicted in FIG. 3b results therefore in a very compact and ergonomic foot controller, suitable for prolonged use, by virtue of requiring little effort to the user in order to impart control signals.

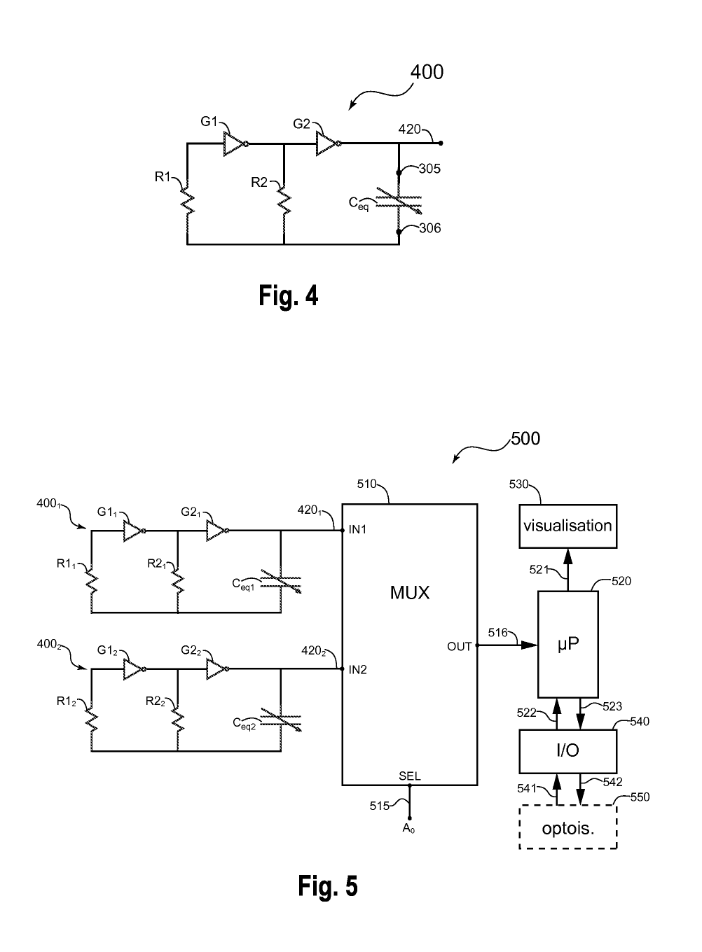

FIG. 4 shows a schematic of a square wave oscillator circuit 400 according to an embodiment the present invention. Oscillator circuit 400 is of the RC type and it is well known in the art. It includes a first loop comprising inverter gate G1 and resistor R1. A second loop comprises resistor R2, inverter gate G2 and variable equivalent capacitor C_{eq} (described above). Connection points 305 and 306, which have been described above with reference to FIG. 3a, are also shown in FIG. 4 in order to clarify that the variable equivalent capacitor C_{eq} is the equivalent capacitor seen between points 305 and 306. Inverter gates G1 and G2 may be, in an embodiment of the present invention, CMOS inverters. It is to be understood that the oscillator circuit 400 can be realised using discrete components and assembled on the same circuit board constituting plate 201 in some embodiments of the present invention, or on a separate PCB. Components G1, G2, R1, and R2 may be discrete components or surface mount devices (SMD) or can be part of an integrated circuit (IC), without departing from the scope of the present invention. It can be easily demonstrated that when the following conditions are met:

2·R2<R1<10·R2 (Eq. 2)

and

1 kΩ<R2<10 MΩ, (Eq. 3)

then the oscillator circuit 400 produces on line 420 a periodic square wave, whose frequency can be expressed as:

$${f}_{osc} = \frac{1}{2.3 \cdot R 2 \cdot {C}_{eq}} \qquad ( Eq . 4 )$$

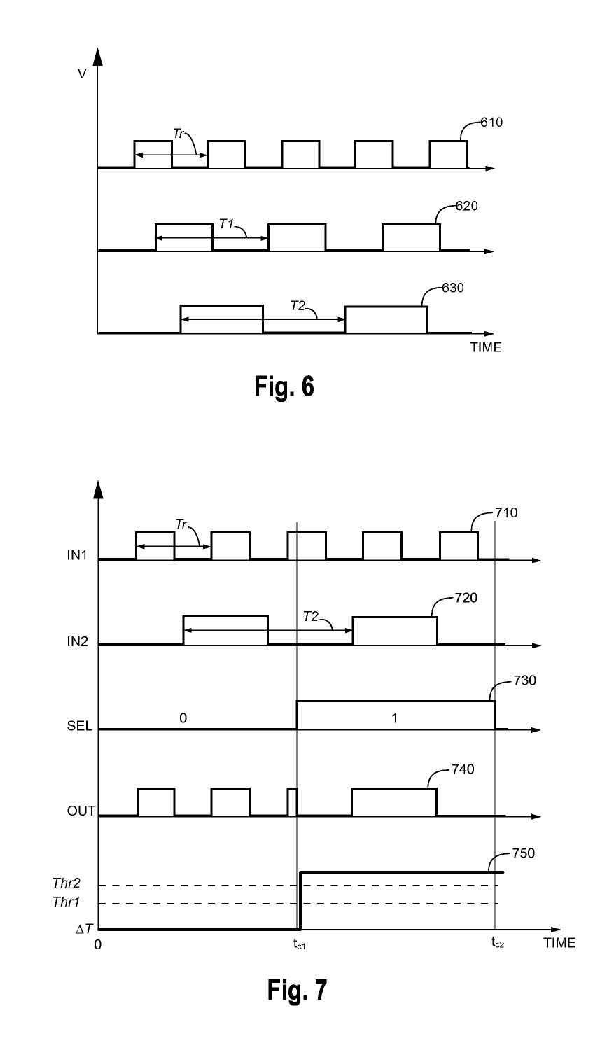

Eq. 4 shows that the frequency f_{osc} of the periodic square wave generated by oscillator circuit 400—and therefore the value of its period T—can be controlled by varying the capacitance C_{eq}. The square wave produced by oscillator circuit 400 is fed to a sensing circuit described hereinafter by means of line 420. Graph 610 in FIG. 6 shows the output voltage on line 420, when oscillator 400 works unperturbed. This is the case, for instance, when no force is applied on sensor pad module 200 and the capacitance value C_{eq} corresponding to the rest position of plate 201.

Depicted in FIG. 5 is the sensing and control circuit 500 of a foot controller, such as foot controller 100 of FIG. 1, in accordance with the present invention. With reference to FIG. 1, under each of the two pads 140 shown therein, lies a sensor pad module of the type described above. As shown in FIG. 5, these sensor pad modules include variable equivalent capacitors C_{eq1} and C_{eq2}. These variable capacitors are included in two independent oscillator circuits of, for instance, the type shown in FIG. 4, whose operating principles have been described above. The sensing and control circuit 500 further includes a multiplexer (MUX) 510, having two inputs N1 and IN2, which receive via signals lines 420₁ and 420₂ the square wave signals produced by the oscillator circuits 400₁ and 400₂. MUX 510 further includes a selector input SEL for a selector signal line 515. In the exemplary embodiment shown in FIG. 5 this line is a 1-bit digital selection signal (bit A₀), which selects which one of the two inputs IN1 and IN2 is connected to the output port OUT of the MUX. The output port OUT is connected via line 516 to a computational device 520. In the exemplary embodiment, the computational device 520 may be implemented with a microprocessor. Those of ordinary skill in this art will understand that the microprocessor 520 could, for instance, be replaced by other computational means capable of carrying out the operations described hereinafter. By way of non-limiting examples only, such computational means may be represented by a digital signal processor (DSP), by one or more field-programmable arrays (FPGA), by application-specific integrated circuits (ASIC), by an external and/or an on-board computer based system, by a processor-containing system, or by other systems that can fetch instruction from a medium and execute the instructions, by software means or any other suitable means. In operation, microprocessor 520 may output the 1-bit digital selection signal A₀ on one of its output lines (not shown in FIG. 5). Alternatively, this signal—which will be described below in more detail—may be generated using other techniques known in the art. This 1-bit digital selection signal, received by MUX 510 via line 515, causes the MUX to direct either one of inputs IN1 or IN2 to its output port OUT, depending on the status of the signal A₀. Microprocessor 520 receives therefore at its input, via line 516, the square wave produced by either one of the oscillator circuits 400₁ or 400₂. Microprocessor 502 is adapted to calculate the period t of the received square wave signal, for instance by sampling the square wave and using a timer to determine the time difference between transitions in the level of the samples. Microprocessor 520 then compares the detected period with one or more predefined thresholds, which may be recalled from a look-up table stored in an internal memory of the types known in the art (e.g. ROM, RAM, flash memory, etc) or in an external data storage (external solid state memory, computer hard or floppy disk, USB flash drive, the Internet, etc). Based on the result of the comparison, microprocessor 520 sends an instruction on line 523 to the I/O (input/output) communication module 540, which takes care of encoding the instruction into a control signal suitable to be understood by peripherals (not shown in FIG. 5) connected to the foot controller. Examples of such peripherals have been given earlier on with reference to connectors 150 to 170 of FIG. 1 and may include, by way of non-limiting example only, one or more expression pedal(s) or similar variable-resistance control devices, a sound processor, a MIDI (Musical Instrument Digital Interface) device, an amplifier or a musical instrument. Other examples of electronic peripherals suitable for receiving controlling signals from the foot controller of the present invention are medical devices of the type to be found in, e.g., operating theatres. I/O module 540 is also adapted to receive information from said peripherals, such as status, programme selected, parameters of musical effects, and many others, and to pass this info to microprocessor 520 for further processing or displaying on visualisation means 530. Although graphically represented as a separate entity from microprocessor 520, it is to be understood that I/O module 540 may be part of microprocessor 520, whether realised as a functional sub-unit of the microprocessor on the same die or as a separated sub-unit within the same case, or it may represent software-performed-functions of microprocessor 520, without departing from the scope of the invention. Optionally, control circuit 500 may be provided with opto-isolator module 550, which may be interposed between I/O module 540 and said peripherals in order to avoid ground loops and/or common mode noise.

Finally, sensing and control circuit 500 may comprise visualisation means 530. Visualisation means 530 may, for instance, provide the user with a visual feedback of the instantaneous force applied by the user onto the controller's sensor module, or it may be used to show other information such as internal status, programmes, menus and parameters of the foot controller or of connected device(s), etc. As explained above, visualisation means 520 may take the form of display means, such as LCD-type display (or of other similar display means known in the art) for displaying information sent to and received from the electronic device(s) connected thereto via the I/O module 540. A display of this type may be used to provide the user with an immediate feedback of, for instance, the status and settings of the foot controller, the operation being performed by the controller, relevant information about the device(s) connected to the foot controller, sensor module's calibration data, and other parameters, which are relevant to the user. In addition or as an alternative to display means of the type discussed above, visualisation means 530 may take the form of feedback means 130 shown in FIG. 1, which may for instance be implemented using light emitting diodes (LED) devices. Under the control of processor 520, visualisation means of this type may be used to provide the user with an immediate visual feedback on the amount of force imparted by the user on the sensor pad module of the foot controller, or on the operation being performed by the controller as a result of an action carried out by the user.

Mode of Operation of the Sensing and Control Circuit.

During the operation of a foot controller according to the present invention, as it has been explained with reference to FIG. 2a to FIG. 2c, a force applied by the user on pad 240 (pad 140 in FIG. 1) causes a geometrical deformation of sensor pad module 200, which in turn corresponds to a variation in the value of the equivalent capacitance C_{eq}. In particular, a variation of the geometry of the sensor pad module such as those depicted in FIG. 2b and in FIG. 2c (starting from the configuration at rest depicted in FIG. 2a) engenders a progressive variation in the value of capacitance C_{eq}. More specifically, if the dielectric constant ∈ᵢ of the material constituting plate 205 is higher than the dielectric constant ∈₂ of material 206, the capacitance C_{eq} will increase, as explained above. In such a case, the more force applied, the higher the value of the capacitance C_{eq}. With reference to the oscillator circuit 400₁ of FIG. 5, this capacitance is the instantaneous capacitance value of variable equivalent capacitor C_{eq1}. When the user applies force on sensor pad module 200, the increase in the capacitance value of capacitor C_{eq1} (compared to the value of said capacitance at rest) entails a decrease in the frequency of the square wave produced by the oscillator circuit, in accordance with Eq. 3, and therefore an increase in the period of the square wave. This is shown in FIG. 6, where graph 610 represents the periodic square wave with period Tr produced by oscillator circuit 400₁ when the sensor pad module is at rest (measured during the initial calibration procedure), graph 620 shows the periodic square wave with period T1>Tr generated while a certain force is applied on the sensor pad module, thereby generating a certain amount of geometrical deformation of the module. Finally, graph 630 shows the periodic square wave with period T2>T1>Tr, generated when a greater amount force, compared to the previous example, is applied on the sensor pad module, thereby producing a greater amount of geometrical deformation of the module.

During the part of the cycle of the 1-bit digital selection signal A₀ in which the square wave on line 420₁ is sent to the microprocessor 520 by MUX 510, the microprocessor will measure the instantaneous value of the period (or of the frequency) of the square wave generated by oscillator circuit 400₁. Since microprocessor 520 is able to discriminate among a number of different values of the period of the square wave, it is possible to use the foot controller to generate different control signals, by defining different ranges (e.g. thresholds) of periods of the square wave. For instance, in correspondence to a measured period Tmeas, it is possible to program or instruct the microprocessor to first compute a quantity ΔT=Tmeas−Tr, i.e. the difference between the measured period and the period of the square wave generated by the same oscillator circuit when the pad is at rest, and then to generate a first control signal 51 if ΔT is less than a first predefined threshold Thr1, a second control signal S2 if Thr1≦ΔT<Thr2 (where Thr2 is a second predefined threshold), or yet a third control signal S3 if ΔT≧Thr2. Typically, but not necessarily, if ΔT is less than said first predefined threshold Thr1, the microprocessor may be programmed to assume that the equivalent capacitor in the sensor pad module is at rest and that, therefore, the user is not imparting any force on the sensor pad module. The microprocessor may be instructed in this case not to generate any control signal.

Subsequently, when the 1-bit digital selection signal A₀ switches from high to low (or vice versa) the signal on line 420₂ is input into microprocessor 520 via MUX 510 and during this part of the cycle of the digital selection signal on line 515 microprocessor 520 will monitor the square wave generated by oscillator circuit 400₂, measure its period (or frequency) and generate the corresponding control signal, which will be sent to the connected peripheral device(s) via I/O module 540.

Since a variation in temperature of the environment in which the foot controller is operating may cause a variation in the elastic response of dielectric plate 201 to the force applied by the user in order to create the geometrical deformation of the sensor module, the sensing and control circuit may include data storage means where correction factors are stored, which allow the microprocessor 520 to compensate for the variation in temperature. For instance, and by way of non-limiting example only, a change in temperature of the operating environment may cause plate 201 to deform or to vary its elastic properties, which in turn may cause the measured period Tmeas and/or the quantity ΔT to be different even if the same force is applied. This may lead the microprocessor to generate the wrong control signal. To avoid such inconveniences to the user, a memory table containing temperature correction factors, modelling the variation of the Young modulus of plate 201 with the temperature, can be stored in an on-board memory or in the memory of the microprocessor. The microprocessor, having measured the current temperature with the help of an optional on-board temperature sensor (not shown) can then either automatically adjust the thresholds or compensate the instantaneous measured period values, in such a way that the user feels that the foot controller responds to the force applied in the way the user is accustomed to. Furthermore, the same technique of applying correction factors stored in memory could be used to linearise the response of the sensor pad module to the force applied to the variations the measured period of the square wave. This may be useful if, for instance, the deformation or the displacement of plate 201 of the sensor pad module is not a linear function of the force applied, which may be due to, e.g., the elastic properties of the materials used for plate 201 or for separation means 210. By applying correction factors and linearising the variation of the measured period of the square wave with the applied force, it is possible to improve the usability of the foot controller from the user's point of view.

FIG. 7 shows the values of various signals in the system of FIG. 5 in a situation in which the user is applying force onto the sensor pad module comprising variable equivalent capacitor C_{eq2}. At instant t=0, the selection signal SEL, graph 730, received by MUX 510 on line 515 is low (logical value 0). This causes the MUX to connect the signal at its input IN1 (graph 710), coming from oscillator circuit 400₁, to its output port OUT. The signal at the output port of the MUX, which is input into microprocessor 520 for measuring its period, is shown by graph 740. Graph 710 shows that the square wave coming from circuit 400₁ has a period Tr corresponding to the rest condition of the variable equivalent capacitor C_{eq1} (the user is not applying any force onto the sensor module that includes C_{eq1}). Graph 750 shows the period measured by microprocessor 520. Between instants t=0 and t=t_{c1} the microprocessor is monitoring oscillator circuit 400₁ and measuring a period of the square wave produced by circuit 400₁ equal to Tr. The quantity ΔT, as defined above, is therefore equal to 0. In such a case, microprocessor 520 may be programmed so as not to execute any instruction, so that the foot controller will not generate any control signal. At instant t=t_{c1} digital selection signal SEL changes to high (logical value 1), which instructs MUX 510 to connect its input IN2 to its output port OUT. Graph 720 shows that input IN2 is receiving a square wave with period T2 from oscillator circuit 400₂, which may correspond to the case in which the user is applying a certain amount of force onto the sensor pad module that includes variable equivalent capacitor C_{eq2}, thereby changing the value of its capacitance. The change in the signal at the output port OUT of the MUX is reflected in graph 740, after instant t=t_{c1}. Therefore, in this part of the cycle of the selection signal in graph 730, microprocessor 520 is monitoring oscillator circuit 400₂ and measuring a period of the square wave produced by circuit 400₂ equal to T2. The microprocessor compares the measured period with the stored threshold values Thr1 and Thr2, detects that the quantity ΔT is now greater than Thr2 (®T>Thr2), and generates the corresponding control signal. At instant t=t_{c2} the selection signal SEL (730) goes low again microprocessor 520 reverts to monitoring oscillator circuit 400₁. Although not shown in FIG. 7, the number and values of thresholds associated with each one of the oscillator circuits present in the foot controller may differ.

The presence of metallic layers 220 and 230 connected to ground potential, beside the advantages already outlined above, makes it possible to integrate multiple sensor pad modules within the same foot controller's enclosure, since it confines the electrical field generated by electrodes 203 and 204 to the specific sensor pad module (for instance 400₁) and avoids that said electrical field is picked up by another oscillator circuit (for instance 400₂) as electromagnetic interference, thereby invalidating the period measurements. If that were to happen, the microprocessor 520 could generate false control signals. For this reason it would be impossible to build a foot controller featuring an array of sensor pad modules of the type describe here using the technology shown in U.S. Pat. No. 3,225,274.

Finally, the mechanical construction of the sensor pad module 200, with distance elements 210 solidly connected to plate 201 and plate 205 and/or plate 230, prevents that mechanical solicitations onto one sensor pad module are transmitted to the adjacent sensor pad module. This renders the sensor pad modules mechanically independent from one another even when they share the same plate 201, that is, electrodes 203 and 204, and metallic layer (ground plane) 220 of adjacent sensor pad modules are etched on the same PCB board. Advantageously, this leads to a simplification in the construction of a foot controller with more than one sensor pad module and to a reduction of its cost.

It should be clear at this point that the construction of the foot controller of the present invention around sensor pad module 200 and sensing circuit 500 makes it possible to realise a novel type of multilevel foot controller, in which one pad can be used to impart as many different control signals as the number of predefined, user adjustable thresholds plus one. It should also be evident that the choice of the number of thresholds and of their value is a trade-off between flexibility of the foot controller, in terms of number of different control signals that can be generated, and the size of the period ranges thus generated. Too many thresholds may require narrow ranges of periods and therefore of force applied, making it perhaps less convenient from the user's point of view, since it may become difficult for a musician playing live to apply the exact force required in order to impart the desired control signal to, e.g., his/her sound processing device if the ranges of force are too narrow. On the other hand, more static situations than a live concert, may afford the user the possibility of modulating more carefully the force applied, thereby enabling him/her to deal successfully with a higher number of narrower ranges of force and to use the foot controller to impart a higher number of different control signals per available sensor pad module. Typically, it has been found by the inventor that two to four different ranges of force—and hence two to four different control signals—per pad sensor module give an optimum balance between flexibility and usability of the foot controller when playing at a live musical performance, but any other number is possible with the technology disclosed herein.

Furthermore, a different number of thresholds may be used with each one of the pad sensor modules included in the foot controller, so that the number of control signals that can be generated by each pad sensor module can be optimally matched to the desired functions associated to that module.

Although the exemplary foot controller of FIG. 1 and FIG. 5 described here above features two sensor pad modules, it is straightforward to realise a foot controller with a number of sensor pad modules ranging from one to virtually any integer number n. The choice of the actual number of sensor pad modules can be seen as a trade-off between the physical size of the foot controller and its versatility. If the controller is to be used with an application or to control a device requiring a relatively small number of different control signals, one or two sensor pad modules may be enough, provided that a sufficient number of thresholds per pad, as described above, is implemented. Likewise, a small number of sensor pad modules may be indicated when a small controller's size is required due to some total size or weight constraints of the particular application; in this case, it is still possible to increase the number of thresholds discriminating between different control signals, in order to ensure that it is possible to send an appropriate number of controls using the foot controller. Conversely, if the physical dimensions of the controller are subject to less stringent requirements, it may be desirable to increase the number of sensor pad modules, which may in turn offer the possibility to reduce the number of thresholds (and therefore control signals) associated with each pad.

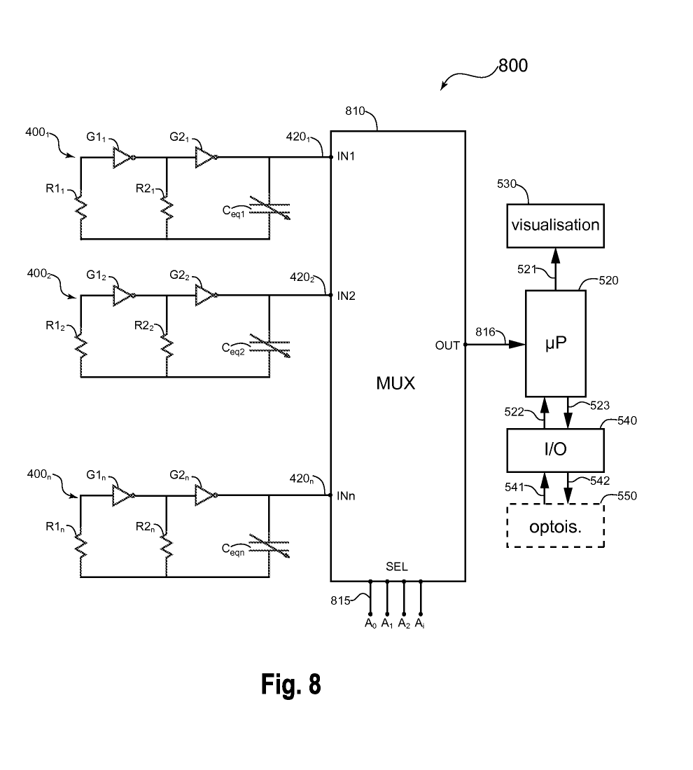

FIG. 8 shows an exemplary embodiment of the sensing and control circuit 800 of a foot controller featuring a number n of sensor pad modules 400₁ to 400ₙ. The mode of operation of such sensing and control circuit is similar to that described above with reference to FIG. 5, with obvious minor adaptations. It is worth pointing out that in a circuit such as that of FIG. 8, the digital selection signal sent to the MUX 810 on lines 815 may be a multi-bit periodic selection signal, which may instruct MUX 810 to connect in rotation each one of input IN₁ to INₙ to its output port OUT. In this way, processor 520 will monitor in rotation each one of oscillator circuits 400₁ to 400ₙ, measure the square waves generated by said circuits, and send the appropriate control signal to the connected peripheral device(s) every time the measured period of any of the square waves meets any one of the conditions defined in the microprocessor's programme, with the help of the thresholds described above. It is clear that it may be advantageous to associate different thresholds, in terms of both the value of the thresholds and their numbers, to different ones of the oscillator circuits (and hence to different controller's sensor pad modules) depending on the function assigned to the sensor pad modules. Implementing a similar feature is readily contemplated within the teachings of the present invention.

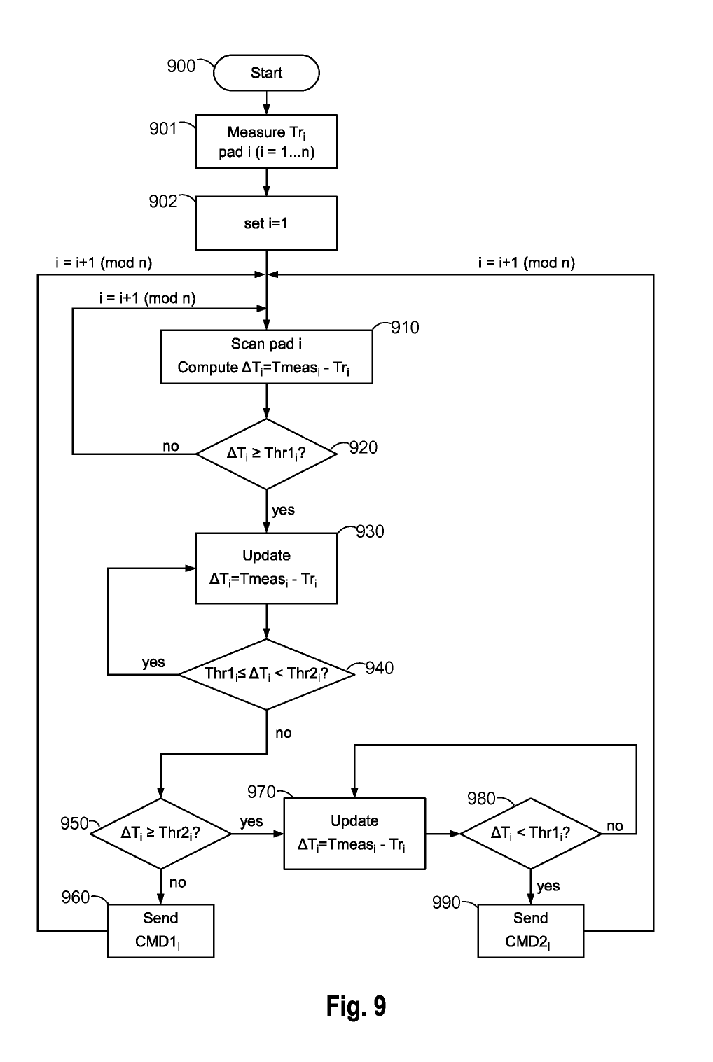

FIG. 9 shows a flowchart of a method for generating control signals from a foot controller of the type disclosed herein, according to an embodiment of the present invention. In the exemplary embodiment illustrated, it is assumed that two thresholds are used on each sensor pad module.

In step 901, the foot controller is initialised and processor 520 measures the period Trᵢ, of the square wave generated the oscillator circuit that includes equivalent capacitor C_{eqi} of the sensor pad module i, where i is an integer ranging from 1 to n, with n corresponding to the number of sensor pad modules included in the foot controller. Period Tr, corresponds to the rest condition of the variable equivalent capacitor C_{eqi}, that is to say when the user is not applying any force to sensor pad module i.

In step 902, having completed the measurement of all Trᵢ periods, the value of i is set to 1 again.

In step 910, using the procedure described above with reference to FIG. 5, FIG. 6, and FIG. 7, processor 520 scan sensor pad module i and determines the instantaneous value Tmeasᵢ of the period of the square wave associated with sensor pad module i, and computes the quantity ΔT=Tmeasᵢ−Tri.

In step 920, it is checked whether quantity ΔT, is greater than or equal to a first predetermined threshold Thr1ᵢ, which may be different for each sensor pad module, as indicated by the index i. If the comparison is negative, processor 502 concludes that the user is not applying (enough) force on the sensor pad module being monitored and moves to monitor the next sensor pad module i+1. Otherwise, if the comparison of step 920 returns a positive result, in step 930, the processor repeats the measurement of the instantaneous value of the period of the square wave associated to the sensor pad module being monitored and recomputes the quantity ΔTᵢ. In step 940, using the updated quantity ΔTᵢ, processor 520 verifies whether Thr1ᵢ≦ΔTᵢ≦Thr2ᵢ, where Thr2ᵢ is a second threshold associated with sensor pad module i. If the condition is verified, steps 930 and 940 are repeated for as long as the condition of step 940 remains verified. This allows the processor to determine whether the user is about to apply more force onto sensor pad module i, in order to generate a control signal corresponding to the second threshold or whether he will cease to apply the force after the first threshold has been exceeded, but not the second threshold. As soon as this condition is no longer verified, processor 520 checks in step 950 one of the two possible condition that may have interrupted the loop of steps 930 and 940.

If in step 950 the processor determines that ΔTᵢ is not greater than or equal to Thr2ᵢ this can only mean that the cycle of steps 930 and 940 has been interrupted by the quantity ΔTᵢ becoming again smaller than Thr1ᵢ (this case corresponds to the “no” exit of decision 950). The processor therefore interprets this fact as the user having stopped to apply force onto sensor pad module i, thereby making the value of the measured period drop towards the value at rest (ΔTᵢ<Thr1ᵢ is again verified). In step 960 the processor therefore generates a first pre-programmed control signal CMD1ᵢ (control signal 1, associated to sensor pad module i), corresponding to the quantity ΔTᵢ having exceeded a first threshold, but not a second threshold.

The method then continues from step 910, after having updated the value of the variable i to i+1 mod n (using modular n arithmetic notation), in order to monitor in the next cycle the next sensor pad module present in the foot controller.

On the other hand, if in step 950 it is determined that instantaneous value of quantity ΔTᵢ is greater than or equal to said second threshold Thr2ᵢ, the processor concludes that the user has increased the force applied to sensor pad module i, in order to generate a different control signal. It is worth reminding that visualisation means 530 of FIG. 5 and FIG. 8, or means 120 and 130 of FIG. 1, may be advantageously configured to provide the user with an instantaneous feedback of the level of force applied to any of the sensor pad modules present.

In this case, in step 970, the quantities Tmeas, and ΔTᵢ are again updated and then the method continues to step 980, where the processor check whether the value of the quantity ΔTᵢ has dropped again below the value of the first threshold Thr1ᵢ, by assessing the condition ΔTᵢ<Thr1ᵢ. Steps 970 and 980 are repeated for as long as this condition is not verified (“no” exit of decision 980). As soon as the condition is verified (“yes” exit of decision 980), the processor interprets this fact as the user having stopped to apply force onto sensor pad module i, thereby making the value of the measured period drop towards the value at rest (ΔTᵢ<Thr1ᵢ is again verified) again. In step 990 the processor therefore generates a second pre-programmed control signal CMD2ᵢ (control signal 2, associated to sensor pad module i), corresponding this time to the quantity ΔTᵢ having crossed also a second threshold.

The method then continues from step 910, after having updated the value of the variable i to i+1 mod n (using modular n arithmetic notation), in order to monitor in the next cycle the next sensor pad module present in the foot controller.

Although the method for generating control signals from a foot controller of the type disclosed herein, has been described, with reference to FIG. 9, using two thresholds for each of the sensor pad modules included in the foot controller, it is readily contemplated within the teaching of the present invention to extend the method to a lower or higher number of thresholds and to the use of a different number of (different) thresholds for each one of the n pads.

Although a few exemplary embodiments of the present invention have been shown and described, it will be appreciated by those skilled in the art that electrical, mechanical, structural and logical changes may be made to the embodiments of the above description without departing from the scope of the present invention as defined in the appended claims and their equivalents.

1. Foot controller for electrically controlling a device by a user comprising:
at least one sensor pad module (200) having a first plate of dielectric material (201) comprising at least two electrodes (203, 204) forming a planar capacitor (C) and a second plate of dielectric material (205) which is separated from the first plate by a layer of compressible dielectric material (206), wherein the dielectric material forming said second plate (205) has a first dielectric constant ∈₁ and the compressible dielectric material (206) has a second dielectric constant ∈₂ with ∈₁≠∈₂, and wherein said first plate (201) is adapted to be displaced with respect to said second plate (205) along the distance between said plates by a force applied by an external object, so as to vary the geometry of an equivalent capacitor (C_{eq}, C_{eq1}, C_{eq2}, C_{eqn}) which includes said at least two electrodes (203, 204), said compressible dielectric material (206), and said second plate of dielectric material (205), thereby varying the value of the capacitance of said equivalent capacitor; and
a control module (500, 800) adapted to generate an electrical control signal that depends on said value of the capacitance.

2. Foot controller according to claim 1, wherein said first dielectric plate (201) is a printed circuit board, said printed circuit board further comprising a first metallic layer on which said two electrodes (203, 204) are etched.

3. Foot controller according to claim 2, wherein said circuit board further comprises a second metallic layer (220) connected to ground potential.

4. Foot controller according to claim 3, wherein said first metallic layer and said second metallic layer (220) are on the opposite outer surfaces of said printed circuit board and wherein said at least two electrodes (203, 204) etched on said first metallic layer faces said layer of compressible dielectric material (206) and said second metallic layer (220) faces the user.

5. Foot controller according to claim 1, wherein said sensor pad module (200) is at least partly enclosed in a fixed housing (110, 111, 112, 250) and wherein said first plate (201) is separated from said second plate (205) by separation means (210) disposed along at least some of the edges of the area occupied by said planar capacitor (203, 204).

6. Foot controller according to claim 5, wherein said separation means (210) is a U-shaped element made of at least one of metal or plastic.

7. Foot controller according to claim 5, wherein said separation means (210) include at least one compression spring or at least one coil spring.

8. Foot controller according to claim 1, wherein said control module comprises at least one oscillator circuit (400, 400₁, 400₂, 400ₙ) which includes said equivalent capacitor (C_{eq}, C_{eq1}, C_{eq2}, C_{eqn}).

9. Foot controller according to claim 8, wherein said oscillator circuit is adapted to produce a periodic waveform, whose period is proportional to said value of the capacitance of the equivalent capacitor (C_{eq}, C_{eq1}, C_{eq2}, C_{eqn}).

10. Foot controller according to claim 9, wherein the control module further includes a computational means (520) adapted to extract the period of said waveform, to compare the period of said waveform with at least one threshold and to perform a predetermined instruction according to the result of said comparison.

11. The foot controller of claim 10, including two or more of said thresholds having different values, thereby defining a number of ranges, and wherein said processor is adapted to perform a predetermined instruction according to the range into which the value of said period is determined to be included as a result of said comparison.

12. The foot controller of claim 10, wherein said thresholds are settable by the user.

13. Foot controller according to claim 1, further including at least a second sensor pad module.

14. Foot controller according to claim 13, wherein said control module comprises:
at least first and second oscillator circuits (400₁, 400₂, 400ₙ) including said equivalent capacitors (C_{eq1}, C_{eq2}, C_{eqn}) of said at least first and second sensor pad modules respectively;
a multiplexer (510, 810) connected to the at least first and second oscillator circuits and adapted to enable the control module to monitor in a time-shared fashion the value of the capacitance of the second capacitor of said at least first and second sensor pad modules; and
wherein said electrical control signals generated by the foot controller depend on the value of the capacitance of the equivalent capacitor included in the sensor pad module being monitored by the control module.

15. Foot controller according to claim 1, wherein the control module is further adapted to read from data storage means correction factors for linearising the response of the sensor pad module to the applied force.

16. Foot controller according to claim 1, wherein the control module is further adapted to read from data storage means correction factors for compensating for variation of operating conditions of the foot controller.

17. Foot controller according to claim 16, wherein said control module further includes a temperature sensor and said variation of operating conditions are variations in the environmental temperature.

18. Foot controller according to claim 1 further comprising communication ports (540) adapted to electrically connect the foot controller to at least one of a sound processor, a computer, a musical instrument, a medical device and adapted to enable said control module to transmit and receive information according to a predetermined communication protocol.

19. Foot controller according to claim 1 wherein said housing (110, 112) is made of metal and incorporates said a metallic layer (230) connected to ground potential.

20. Method for generating control signals from a foot controller, comprising the steps of:
a. Measuring (901) the period at rest of a periodic square wave, generated in the foot controller by at least one oscillator circuit including a variable capacitor, whose geometry is susceptible to be modified by the user, whereby the period at rest is defined as the period of the square wave generated when said geometry is not being modified by the user;
b. Measuring (910) the instantaneous value of the period of said periodic square wave and computing the difference between said instantaneous period and said period at rest;
c. Comparing (920) said difference with a first predetermined threshold;
d. If the difference is smaller than said first threshold, repeating step b and c;
e. Otherwise, if the difference is greater than or equal to said first threshold, comparing (940) said difference with a second threshold, wherein said second threshold is greater than said first threshold;
f. If said difference is smaller than said second threshold, executing the sub-steps of:
f1. Measuring (930) said instantaneous value of said period, updating said difference, and comparing (940) it with said first threshold until said difference becomes again smaller than said first threshold;
f2. Generating (960) a first predetermined control signal.
g. Otherwise, if said difference is greater than or equal to said second threshold, executing the sub-steps of:
g1. Measuring (970) said instantaneous value of said period, updating said difference, and comparing (980) it with said first threshold until said difference becomes again smaller than said first threshold;
g2. Generating (990) a second predetermined control signal.

21. Method according to claim 20, wherein step e includes, prior to executing said comparing (940), executing the step of measuring (930) the instantaneous value of the period of said periodic square wave and updating the difference between said instantaneous period and said period at rest.

22. Method according to claim 20, wherein step g includes, before executing steps g1 and g2, the further sub-step of:
ga. Comparing said difference with a third predetermined threshold, wherein said third threshold is greater than said second threshold;
gb. If said difference is smaller than said third threshold, executing sub-steps g1 and g2;
gc. If said difference is greater than or equal to said third threshold, executing a modified version of sub-steps g1 and g2, in which said second predetermined control signal is replaced by a third predetermined control signal.
